(19) United States
(12) Patent Application Publication
(10) Pub. No.: US 2018/0166677 A1
(43) Pub. Date: Jun. 14, 2018

(54) Battery Protection Device

(71) Applicant: Blue Solutions Canada Inc., Boucherville (CA)

(72) Inventors: Jonathan MORTREUX, St-Lambert (CA); Yvan ROY, St-Hubert (CA); Claude CARIGNAN, Varennes (CA); Nicolas POTIER, Val-Morin (CA)

(21) Appl. No.: 15/375,117

(22) Filed: Dec. 11, 2016

(51) Int. Cl. H01M 2/34; H01M 2/30; H01M 2/20; H01M 2/26; B60L 11/18

(52) U.S. Cl. CPC H01M 2/348; H01M 2/305; H01M 2/206; H01M 2200/10; B60L 11/1859; H01M 2220/20; H01M 2/26

(57) ABSTRACT

A battery including an autonomous protection device electrically connected in series between the plurality of electrochemical cells and one of the positive pole and the negative pole of the battery.

### CROSS REFERENCE

This application claims priority from U.S. 62/266,029, the contents of which are incorporated herein by reference.

### FIELD OF THE INVENTION

The present invention relates to a battery for electric vehicles, hybrid vehicles or stationary applications and more specifically to a battery having a protection device.

### BACKGROUND OF THE INVENTION

Battery packs for electric vehicle typically include multiple batteries of various voltages connected in series via high gauge wire connecting the positive and negative poles of the batteries. The total voltage of a battery pack in an electric vehicle can reach up to 600 volts when all batteries are connected together.

Battery packs consist of a plurality of batteries assembled in series with high gauge wires. Safety devices have been installed between each battery of a battery pack to ensure that the electrical connection between each battery will be disconnected in the event of an emergency such as one of the battery of the battery pack being subject to a short circuit or the vehicle carrying the battery pack being involved in a collision. Fuses have been used in small batteries to cut off electrical current when the latter exceeded a certain threshold. However, fuses are ineffective for high voltage battery packs since when the fuse is blown, arcing occurs due to the high voltage and arcing causes other damages which can result in more problematic situations. Another type of safety device is described in U.S. Pat. No. 8,709,628 which is herein incorporated by reference. U.S. Pat. No. 8,709,628 describes an electrical connector comprising an interrupter having a pyrotechnic element adapted to severe the electrical connection between the batteries in case of an emergency. The pyrotechnic element is triggered by an electrical signal received from an electronic control unit (ECU) sensing a failure or a collision.

One drawback of the safety device described in U.S. Pat. No. 8,709,628 is that the battery pack itself is disabled by the safety device in an emergency but the batteries of the pack remain alive and therefore still represent an electrical hazard. A second drawback of the safety device described in U.S. Pat. No. 8,709,628 is that it is triggered by an electrical signal received from an electronic control unit (ECU) however the ECU may be disabled or the electrical source severed during an emergency and the ECU may not be able to send an electrical signal to the pyrotechnic element in order to disconnect the batteries such that the battery pack remains alive and still represent an electrical hazard.

Therefore, there is a need for a protection device for a battery that independently disables individual batteries in a battery pack in an emergency situation.

### SUMMARY OF THE INVENTION

It is an object of the present invention to ameliorate at least some of the inconveniences present in the prior art.

It is also an object of the present invention to provide a battery comprising: a positive pole and a negative pole, a plurality of electrochemical cells inside the enclosure, the plurality of electrochemical cells electrically connected to the positive pole and the negative pole of the battery, and an autonomous protection device electrically connected in series between the plurality of electrochemical cells and one of the positive pole and negative pole of the battery; the protection device having a conductive element for electrically connecting the plurality of electrochemical cells to the positive pole or negative pole and an interrupter; the protection device connected to and controlled by an independent circuit comprising a normally open thermostat-switch and a capacitor having an electrical charge stored therein, the thermostat-switch closing the independent circuit when the temperature inside the sealed casing reaches a pre-determined temperature thereby releasing the electrical charge from the capacitor to the protection device and triggering the interrupter of the protection device to disconnect the plurality of electrochemical cells from the positive pole or negative pole and disabling the battery.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a downward front perspective view of a portion of an battery pack connected in series;

FIG. 2 is a left side perspective view of a single battery of the battery pack shown in FIG. 1 with a cut-away portion showing the internal components of the battery;

FIG. 3 is a left side perspective view of the front portion of the single battery shown in FIG. 2 with the front cover removed showing the protection device in accordance with one embodiment of the invention;

FIG. 4 is a front elevational view of the front portion of the single battery shown in FIG. 2 with the front cover removed showing the protection device in accordance with one embodiment of the invention; and

FIG. 5 is a schematic view of the internal components of the protection device shown in FIGS. 3 and 4.

### DETAILED DESCRIPTION OF THE PREFERRED EMBODIMENTS

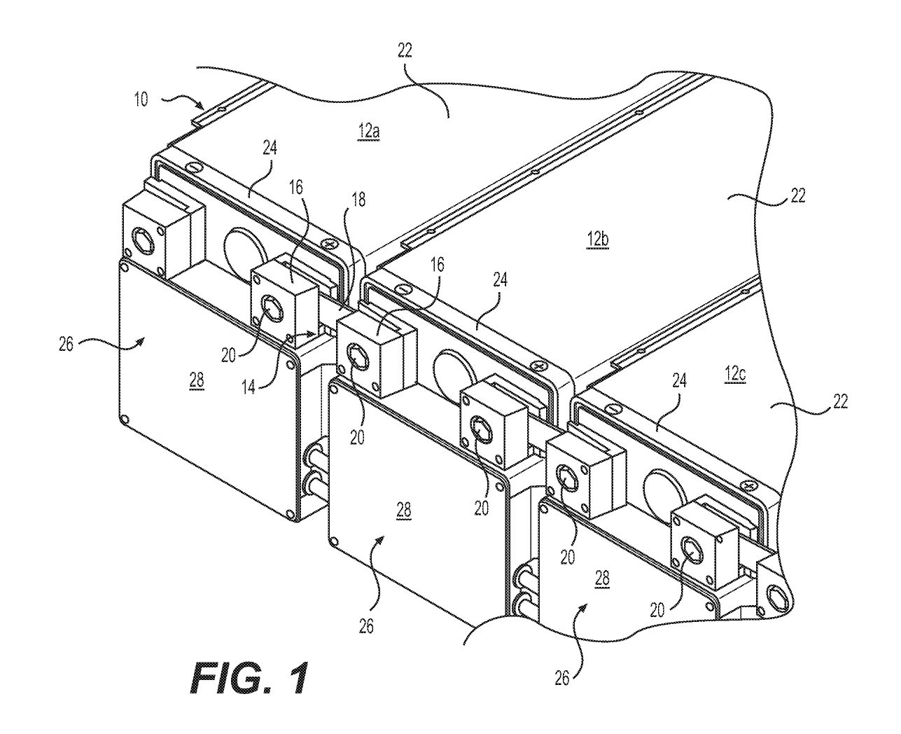

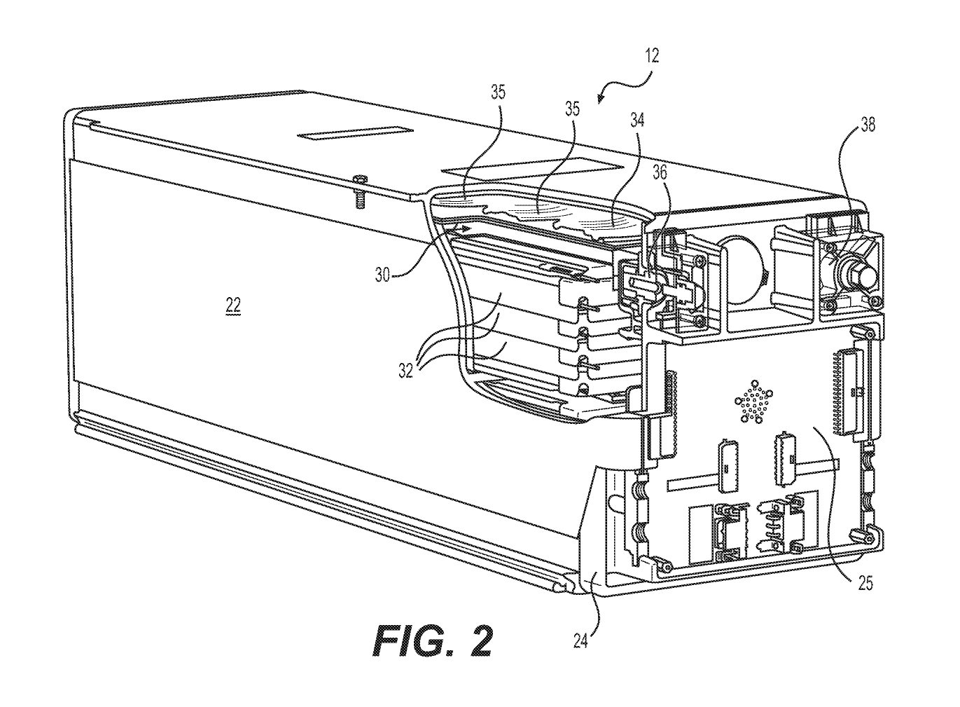

With reference to FIG. 1, there is shown a portion of a battery pack 10 including a plurality of batteries 12a, 12b, 12c . . . connected in series via battery connectors 14. In FIG. 1, the positive pole of battery 12a is connected to the negative pole of battery 12b, and the positive pole of battery 12b is connected to the negative pole of battery 12c. Each battery connector 14 includes an electrically conductive bridge 18, battery pole covers 16 made of an electrically insulating plastic and a pair of fasteners 20 adapted to connect the extremities of the conductive bridge 18 to the positive and negative poles of adjacent batteries. Each battery 12 of the battery pack 10 includes a rigid casing 22 and a cover 24 adapted to seal the rigid casing 22 to form a sealed casing housing the electrochemical cells of the battery 12. Each cover 24 includes a forward compartment 26 housing an electronic control system 25 (FIG. 2) for managing the battery state and the charge and discharge functions of the battery 12. The compartment 26 is sealed with a sealing plate 28 to ensure that the compartment 26 is hermetic.

With reference to FIG. 2, there is shown a single battery 12 with a cut-away portion showing the internal components of each battery 12 and the sealing plate 28 removed showing the electronic control system 25. As illustrated, the rigid casing 22 and the sealing cover 24 together define an enclosure 30 in which is housed a plurality of flat electrochemical cells 32 stacked together. A mechanical pressure system 34 comprising a plurality of springs 35 is also inserted into the sealed casing 22 to provide the required mechanical pressure for optimal performance of the stack of electrochemical cells 32. The negative side of the plurality of electrochemical cells 32 are connected to the negative pole 36 of the battery 12 and the positive side of the plurality of electrochemical cells 32 is connected to the positive pole 38 of the battery 12.

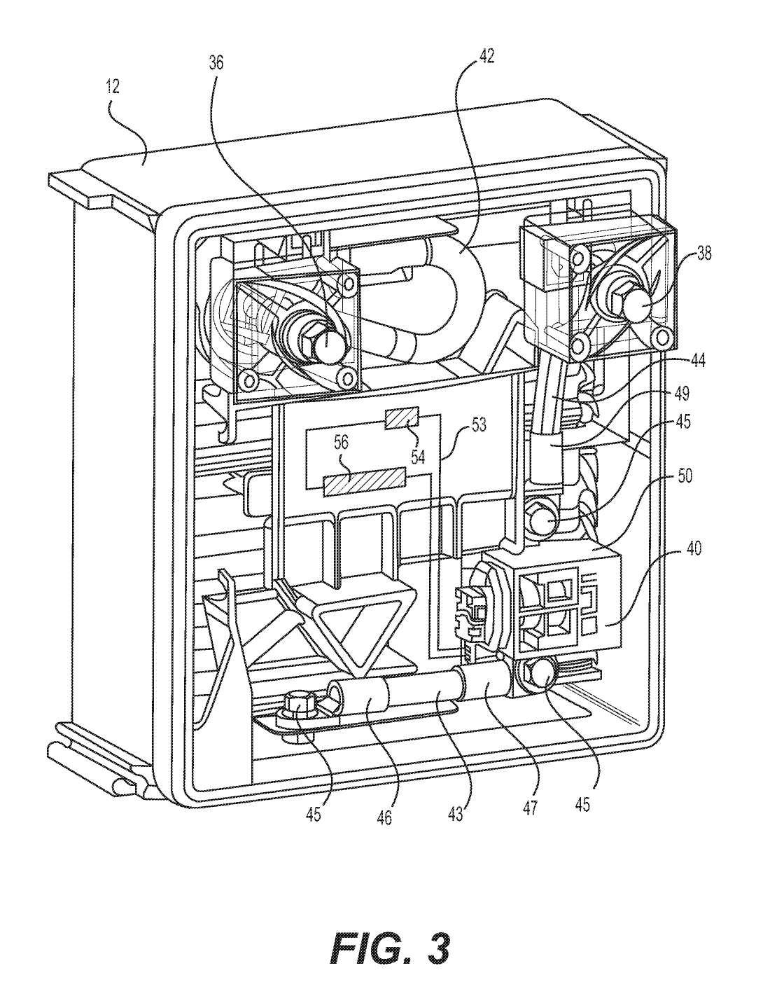

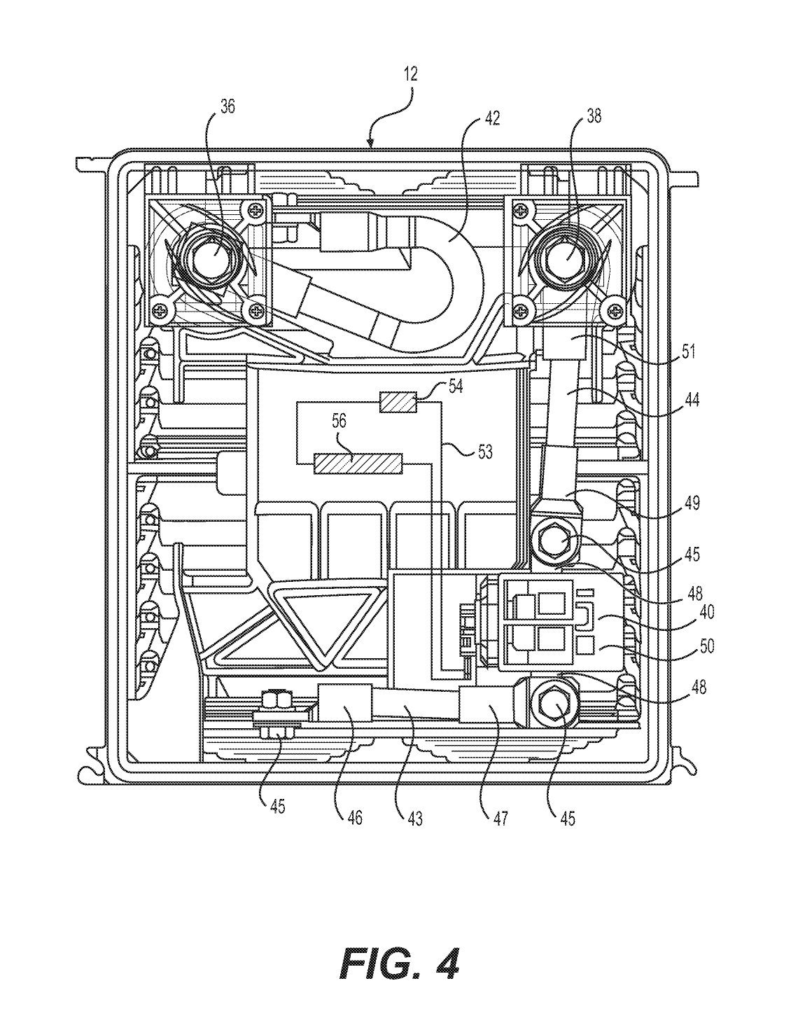

With reference to FIGS. 3 and 4, which illustrate the front portion of the battery 12 with the sealing cover 24 removed. The negative side of the plurality of electrochemical cells 32 are connected to the negative pole 36 via a high gauge wire 42 whereas the positive side of the plurality of electrochemical cells 32 is connected to the positive pole 38 of the battery 12 via a first high gauge wire 43 connected to a protection device 40 which is connected to the positive battery pole 38 via a second high gauge wire 44 such that the protection device 40 is connected in series between the plurality of electrochemical cells 32 and the positive pole 38 of the battery 12. More specifically, the protection device 40 includes a conductive element 48 (FIG. 4) traversing the body of the protection device 40 and extending on both sides of the body 50 of the protection device 40 allowing current to pass through the protection device 40 from the plurality of electrochemical cells 32 to the positive battery pole 38. The first high gauge wire 43 is connected at one end 46 to the positive side of the electrochemical cells 32 via a fastener 45 and connected at the other end 47 to one extension of the conductive element 48 via a second fastener 45. The second high gauge wire 44 is connected at one end 49 to a second extension of the conductive element 48 via a fastener 45 and connected at the other end 51 to the positive battery pole 38. Obviously, the protection device 40 could be connected in series between the plurality of electrochemical cells 32 and the negative battery pole 36. The protection device 40 may be connected in series between the electrochemical cells 32 and either one of the positive pole 38 or the negative pole 36 of the battery 12.

The protection device 40 is connected and controlled by an independent circuit 53 comprising a thermostat-switch 54 and a capacitor 56 having a stored electrical charge therein. The thermostat-switch 54 is in the normally open position such that no current flows through the independent circuit 53. The thermostat portion of the thermostat-switch 44 is set to activate and close the switch portion of the thermostat-switch 54 at a pre-determined temperature indicative of an internal short-circuit of the battery 12, an abnormal rise of temperature caused by an external source, an uncontrolled charge or discharge or a breach of the rigid casing 22 or the cover 24. The pre-determined temperature is set depending on the type of electrochemical cells. For lithium metal polymer electrochemical cells, the threshold temperature is set between 135° C. and 170° C. For lithium-ion electrochemical cells, the threshold temperature is set between 60° C. and 70° C. For Sodium-Sulfur electrochemical cells, the threshold temperature is set between 200° C. and 275° C. When the temperature of the battery 12 rises to the pre-determined temperature, the thermostat-switch 54 is activated thereby closing the normally open circuit 53 and releasing the electrical charge from the capacitor 56 and activating the protection device 40 to cut the current from the electrochemical cells 32 to the positive pole 38 and disabling the battery 12.

The protection device 40 includes a conductive element 48 made of an electrically conductive metal such as copper and an interrupter 57. The central portion of the conductive element 48 passes through the interrupter 57. The interrupter 57 is a pyrotechnic device adapted to cut the central portion of the conductive element 48 in the event of an internal short-circuit or other anomalies which raise the temperature of the battery 12. The interrupter 57 includes a small pyrotechnic charge that, when activated, generates an impulse load on a mechanical cutter that cuts the central portion of the conductive element 48 thereby disconnecting the positive battery pole 38 and electrically isolating the battery 12.

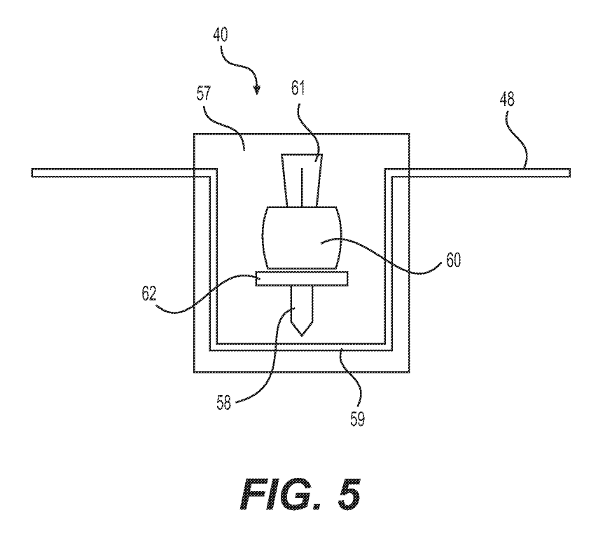

In a specific embodiment as shown in FIG. 5 which is a schematic illustration, the interrupter 57 includes a wedge 58 aligned with the central portion 59 of the conductive element 48 which is actuated by a pyrotechnic charge 60 that cuts the central portion 59 of the conductive element 48 permanently in the event of an internal short-circuit or other anomalies. As previously described, when the internal temperature of the battery 12 reaches a pre-determined temperature, the thermostat-switch 54 closes and an electrical current is discharged into the interrupter 57 triggering an igniter 61 that set off the pyrotechnic charge 60 which generates an impulse on a pressure plate 62 that instantly pushes the wedge 58 against the central portion 59 of the conductive element 48, thereby cutting the conductive element 48 and severing the electrical connection between the electrochemical cells 32 and the positive battery pole 38 and disabling the battery 12.

The protection device 40 as well as the independent circuit 53 including the thermostat-switch 54 and the capacitor 56 are preferably located inside the seal casing behind the sealing cover 24 to ensure that it cannot be damaged or tempered with by a technician. However, the protection device 40 could located within the compartment 26 of the battery 12.

Because the protection device 40 is connected and controlled by the independent circuit 53 which is powered by the capacitor 56, the protection device is autonomous and does not depend on an internal or external ECU to be activated in the event of an emergency. Preferably, the protection device 40 is also connected to an Electronic Control Unit (ECU) in parallel with the independent circuit 53 such that the protection device 40 may also be triggered by the ECU in the event of a vehicle collision for example. The Independent circuit 53 is a failsafe system in case the ECU is disabled.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A battery comprising:
a positive pole and a negative pole;
a plurality of electrochemical cells, the plurality of electrochemical cells electrically connected to the positive pole and the negative pole of the battery,
an autonomous protection device electrically connected in series between the plurality of electrochemical cells and one of the positive pole and negative pole of the battery; the protection device having a conductive element for electrically connecting the plurality of electrochemical cells to the positive pole or negative pole and an interrupter; the protection device connected to and controlled by an independent circuit comprising a normally open thermostat-switch and a capacitor having an electrical charge stored therein, the thermostat-switch closing the independent circuit when the temperature inside the sealed casing reaches a pre-determined temperature thereby releasing the electrical charge from the capacitor to the protection device and triggering the interrupter of the protection device to disconnect the plurality of electrochemical cells from the positive pole or negative pole and disabling the battery.

2. A battery as defined in claim 1, wherein the protection device further comprises a central portion of the conductive element passing through the interrupter, the interrupter including an igniter, a pyrotechnic charge and a mechanical cutter adapted to cut the central portion of the conductive element, the igniter firing the pyrotechnic charge when the thermostat-switch is closed which then pushes the mechanical cutter to cut the central portion of the conductive element thereby disconnecting the plurality of electrochemical cells from the positive pole or negative pole of the battery.

3. A battery as defined in claim 1 further comprising a sealed casing defining an enclosure, the plurality of electrochemical cells located inside the enclosure and the positive pole and the negative pole extending outside the sealed casing.

4. A battery as defined in claim 3, wherein the protection device is located inside the sealed casing.

5. A battery as defined in claim 3, wherein the independent circuit is located inside the sealed casing.

6. A battery as defined in claim 1, wherein the protection device is also connected to an Electronic Control Unit (ECU) in parallel with the independent circuit.
